(19) United States
(12) Patent Application Publication
(10) Pub. No.: US 2004/0170097 A1
(43) Pub. Date: Sep. 2, 2004

(54) Rotational velocity controlling system for information recording medium

(75) Inventor: Yasuhisa Mashiko, Osaka (JP)

Correspondence Address: Jack Q. Lever, Jr., McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/786,080

(22) Filed: Feb. 26, 2004

(30) Foreign Application Priority Data
Feb. 28, 2003 (JP) 2003-053382

(51) Int. Cl. G11B 7/00

(52) U.S. Cl. 369/53.3

(57) ABSTRACT

A control information generating circuit uses linear velocity information at a recording/reproduction position on an optical disc, which is obtained from an information recording medium by a synchronous signal cycle counter, and revolution number information, which is obtained from a rotation mechanism by a cycle counter of a frequency generator, to generate a piece of rotation control information, and the resultant information is supplied to a motor driving circuit. A variation detecting circuit generates a linear velocity abnormality detecting signal based on an abnormality detection result obtained by a division circuit, thereby preventing an abnormal operation of a spindle motor. With such a structure, switching of the control mode between CAV control mode and CLV control mode in a continuous recording/reproduction operation on an optical disc, or the like, is smoothly performed using one pierce of rotation control information. Furthermore, the disturbance in CLV control, which may occur due to a flaw on an information recording medium, or the like, is reduced.

### BACKGROUND OF THE INVENTION

The present invention relates to a rotational velocity controlling system used in an information recording/reproducing apparatus which records/reproduces information on/from an information recording medium, such as a CD (Compact Disc), a CD-R/RW (Compact Disc Recordable/Rewritable), or the like.

In optical discs, such as a CD, and the like, the physical format employed for recording of information is determined based on CLV (Constant Liner Velocity) method for the purpose of increasing the information storage capacity.

In these optical discs, it is necessary to change the number of revolutions of a disc according to the physical radial position on the disc at which recording or reproduction is performed in order to perform the recording or reproduction with a constant linear velocity (hereinafter, referred to as “(perform) CLV recording/reproduction”). Specifically, the number of revolutions at a radial position 25 mm distant from the center of the disc must be twice the number of revolutions at a radial position 50 mm distant from the center of the disc. In the CLV recording/reproduction method, rotation control information is generally obtained by means for detecting the linear velocity based on a signal recorded in a disc in advance.

There is a case where recording/reproduction is performed based on CAV (Constant Angler Velocity) mode although the recording format is determined based on the CLV method. In this case, the signal processing speed in an information recording/reproducing process is changed according to the physical radial position on a disc at which recording or reproduction is performed. In the CAV recording/reproduction method, rotation control information is generally obtained from a FG (frequency generator) attached to a rotation shaft, or the like.

The CLV and CAV recording/reproduction methods have different advantages. Hereinafter, the CLV and CAV recording/reproduction methods are described while considering the recording/reproduction speed that is one of the most important factors in an information recording medium.

In the CLV recording/reproduction method, recording/reproduction can be performed over the entire surface of a recording medium with the limit speed for the information reading system and electric information processing system (hereinafter, referred to as “signal processing system”) at the time of development of a disc apparatus which is imposed due to optical systems, or the like. Thus, the CLV recording/reproduction method is most desirable for the recording/reproduction speed.

The CAV recording/reproduction method is desirable when the number of revolutions of a recording medium at the limit speed of the signal processing system is not achieved due to mechanical restrictions on a rotation mechanism. Hereinafter, the reasons therefor are specifically described.

First, consider a case where, in the specifications of CD, the limit speed of the signal processing system which is imposed due to optics is 100× speed, and the limit number of revolutions of a disc rotation mechanism is 10000 rpm. In this case, the number of revolutions of a disc in a 100×-speed mode results in about 50000 rpm at inner tracks and about 20000 rpm at outer tracks. This means that the number of revolutions of the disc exceeds the limit value of the disc rotation mechanism anywhere on the disc. Thus, the limit value of the recording/reproduction speed is determined by the limit number of revolutions of the disc rotation mechanism. In such a case, the average recording/reproduction speed over the entire disc surface becomes the maximum when the CAV recording/reproduction method is used.

Comparing with the above, a case where the limit speed of the signal processing system is close to the limit value of the disc rotation mechanism is now considered. Specifically, consider a case where the limit speed of the signal processing system is 30×-speed, for example. In this case, the number of revolutions of a disc in CLV recording/reproduction results in about 15000 rpm at the inner tracks and about 6000 rpm at the outer tracks. In this case, the limit of the recording/reproduction speed is determined by the capacity of the disc rotation mechanism at the inner tracks, whereas the limit of the recording/reproduction speed is determined by the capacity of the signal processing system at the outer tracks. In order to achieve the maximum average recording/reproduction speed over the entire disc surface, the control method is switched such that the CAV recording/reproduction method is used at inner tracks and the CLV recording/reproduction method is used at outer tracks. This technique is described in, for example, Japanese Unexamined Patent Publication No. 2001-256718. Actually, there has already been a CD recording/reproducing apparatus designed according to the above-described specifications.

However, in the above-described CLV recording/reproduction method, the rotation control information cannot be correctly obtained when a flaw exists on an information recording medium because the rotation control information is extracted from information recorded on the information recording medium. It should be noted that such a problem does not occur in the CAV recording/reproduction method because the rotation control information is obtained from a FG (frequency generator) attached to a rotation shaft, or the like.

In the case where the CLV and CAV recording/reproduction methods are switched according to the physical radial position on a disc, a CLV control circuit and a CAV control circuit are provided independently from each other, and the outputs of these circuits are selectively used. Therefore, smooth switching of the control methods is difficult. In this respect, especially for CD-R/RW where it is required to realize the mode of continuously recording information over the entire disc surface, which is called DAO (Disc At Once) mode, in an apparatus where the mode of rotation control is switched, disturbance in the rotational velocity of a recording medium cannot be avoided at the time of mode switching, and it is difficult to smoothly record information over the entire disc surface at once.

The present invention overcame the above problems. An objective of the present invention is to enable recording of information over the entire disc surface at once while switching between the CLA recording/reproduction mode and the CAV recording/reproduction mode, without causing a disturbance in the rotation speed of an optical disc in the CLV control or at the time of switching the disc rotation control mode even when a flaw exists on the disc surface.

### SUMMARY OF THE INVENTION

For the purpose of achieving the above objective, in the present invention, we focused attention on the point that revolution number information and linear velocity information have a relationship of opposite limit characteristics with respect to an information recording position in a radial direction on a rotational information recording medium, such as an optical disc, or the like, i.e., a relationship such that the limit of the recording/reproduction speed is defined by the capacity of the rotation mechanism at inner tracks on an optical disc, or the like, whereas the limit of the recording/reproduction speed is defined by the signal processing capacity at outer tracks.

Specifically, the relationship between the limit of the rotation mechanism and the limit of the signal processing capacity at a physical radial position on the recording medium is applied to the relationship of a division formula of the revolution number information and the linear velocity information at the physical radial position on the recording medium to obtain position information as to a position where the limit of the rotation mechanism and the limit of the signal processing system switch with each other. The rotation of the optical disc is controlled based on the obtained information such that the average recording/reproduction speed achieves the maximum value, and the number of revolutions is continuously controlled so as to follow the variation in the linear velocity.

Error information of the revolution number information and error information of the linear velocity information are both canceled by the division operation, and revolution number information not including error information is generated using a result of the division operation. Furthermore, the error in the number of the revolutions (revolution number error) which is generated as a result of such an operation is used to remove the error from the number of revolutions of the optical disc, whereby CLV control is achieved without disturbance. In addition, the change in the operation result is monitored to detect an abnormality in the linear velocity.

Specifically, a rotational velocity controlling system for an information recording medium according to the present invention is a rotational velocity controlling system in an information recording/reproducing apparatus which records and reproduces information on/from an information recording medium, the system comprising: revolution number detecting means for detecting the number of revolutions of the information recording medium; linear velocity detecting means for detecting the linear velocity at an information recording/reproduction position on the information recording medium; control information generating means for generating rotation control information used for controlling the rotational velocity of the information recording medium based on the revolution number information obtained by the revolution number detecting means and the linear velocity information obtained by the linear velocity detecting means; and driving means for rotating the information recording medium based on the rotation control information generated by the control information generating means.

According to the rotational velocity controlling system of the present invention, the control information generating means uses the revolution number information obtained by the revolution number detecting means and the linear velocity information obtained by the linear velocity detecting means to divide one of these information by the other; the control information generating means generates a revolution number error from the revolution number information based on an operation result value obtained by the division; and the control information generating means outputs the revolution number error as the rotation control information to the driving means.

According to the rotational velocity controlling system of the present invention, the control information generating means includes numerical range limiting means for limiting the numerical range of the operation result value.

According to the rotational velocity controlling system of the present invention, the numerical range limiting means is upper limit means for limiting an operation result value which exceeds a predetermined value to the predetermined value.

The rotational velocity controlling system of the present invention further comprises abnormality detecting means for detecting occurrence of an abnormality in the output of the linear velocity detecting means according to the relationship between the revolution number information and the linear velocity information.

With the above features, according to the present invention, the relationship between the revolution number information obtained by the revolution number detecting means and the linear velocity information obtained by the linear velocity detecting means is utilized to generate revolution number control information. Thus, even when an abnormality occurs during detection of the linear velocity due to damage on the information recording medium, such as a flaw, the abnormality is detected by detecting a change which occurs in the relationship, and disturbance in the CLV control is prevented. Further, rotation control is performed based on a piece of rotation control information without handling any of the CLV control and the CAV control independently. Thus, switching between the CLV control and the CAV control is smoothly performed.

According to the present invention, a division operation is performed using the revolution number information and the linear velocity information, and a revolution number error is generated from the revolution number information based on a result of the division operation. The generated revolution number error is used to control the driving means. Thus, the error is removed from the number of revolutions of the optical disc, whereby the CLV control is performed without disturbance.

According to the present invention, the control information generating means includes a numerical range limiting means, so that a limited output value is supplied to the driving means as the rotation control information. Accordingly, the CAV control is performed with a constant number of revolutions. Therefore, in the case where the operation result value is a quotient obtained by dividing the revolution number information by the linear velocity information, the quotient decreases as the position shifts towards an outer track of the optical disc. Thus, the driving means is CAV-controlled when a limit value set in the numerical range limiting means is equaled or exceeded. When the operation result value decreases to be smaller than the limit value, the operation result value is released from the limit value and starts to decrease. That is, when passing across the limit value which is a boundary value, the operation result value continuously changes without making an irregular change at the boundary. Thus, the operation value is continuously changed by one limiting means over the entire range of the operation result value. Accordingly, the rotation control information also continuously changes so that switching from the CAV control to the CLV control is smoothly performed. In the case where the operation result value is a quotient obtained by dividing the linear velocity information by the revolution number information, the revolution number information changes continuously for the same reason.

According to the present invention, the abnormality detecting means monitors the relationship between the revolution number information and the linear velocity information. In the case where an abnormality occurs in the output of the linear velocity detecting means due to damage on an information recording medium, such as a flaw, or the like, the relationship between the information abruptly changes. Thus, an abnormal change resulting from the damage on the information recording medium can be detected. Furthermore, some countermeasure is provided such that, for example, the driving means is not controlled when the abnormality is detected, whereby occurrence of a disturbance in the CLV control is prevented.

### BRIEF DESCRIPTION OF THE DRAWINGS

FIG. 1 is a block diagram showing the entire structure of a rotational velocity controlling system for an information recording medium according to an embodiment of the present invention.

FIG. 2 is a table which shows desirable output values from respective blocks of the rotational velocity controlling system for an information recording medium according to an embodiment of the present invention.

FIG. 3 is a table which shows output values including errors from respective blocks of the rotational velocity controlling system for an information recording medium according to an embodiment of the present invention.

### DESCRIPTION OF THE PREFERRED EMBODIMENTS

Hereinafter, a rotational velocity controlling system for an information recording medium according to an embodiment of the present invention is described with reference to the drawings.

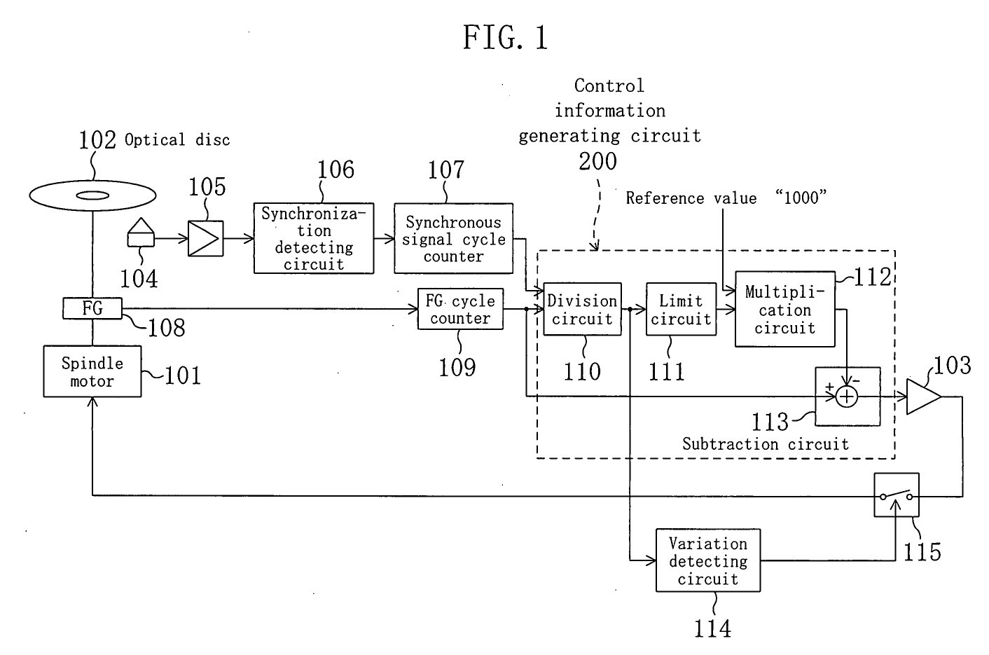

FIG. 1 is a block diagram showing the structure of an information recording/reproducing apparatus which records/reproduces information on/from an information recording medium. The information recording/reproducing apparatus of FIG. 1 includes a rotational velocity controlling system for an information recording medium according to an embodiment of the present invention.

In FIG. 1, a spindle motor 101 is driven by a motor driving circuit (driving means) 103 to rotates an optical disc (information recording medium) 102. An optical head 104 emits laser light onto the information recording medium to record information and receives laser light reflected by the information recording medium to read recorded information, whereby recording and reproduction are performed on the optical disc 102. A feeble signal read by the optical head 104 from the optical disc 102 is amplified by a reproduction amplifier 105 and input to a synchronization detecting circuit 106. The synchronization detecting circuit 106 extracts a synchronous signal from the signal amplified by the reproduction amplifier 105. A synchronous signal cycle counter (linear velocity detecting means) 107 receives the synchronous signal and counts the cycles of the synchronous signal, thereby detecting the linear velocity in a tangential direction of the optical disc 102 at a position on the optical disc 102 at which information is recorded or reproduced. The synchronous signal cycle counter 107 outputs linear velocity information which is in proportion to the detected linear velocity.

A frequency generator 108, which is attached to a rotation shaft of the spindle motor 101, outputs a FG signal to a FG cycle counter (revolution number detecting means) 109. The FG signal is in proportion to the number of revolutions. The FG cycle counter 109 counts the cycles of the FG signal to detect the number of revolutions of the optical disc 102 and outputs revolution number information which is in proportion to the detected number of revolutions.

Reference numeral 200 denotes a control information generating circuit (control information generating means), which includes a division circuit 110, a limit circuit 111, a multiplication circuit 112 and a subtraction circuit 113. The control information generating circuit 200 divides the revolution number information input from the FG cycle counter 109 by the linear velocity information input from the synchronous signal cycle counter 107. The control information generating circuit 200 establishes a relationship by performing an arithmetic operation based on a quotient obtained by the above division. The control information generating circuit 200 generates rotation control information according to the relationship for controlling the rotational velocity of the optical disc 102. The rotation control information output from the control information generating circuit 200 is supplied to the motor driving circuit 103 as a signal for controlling the rotation of the optical disc 102.

Now, the structure of the control information generating circuit 200 is further described in detail. In the present embodiment, it is assumed that the limit speed of a signal processing for recording/reproduction of information exceeds the limit of rotation of the optical disc 102 in the vicinity of the innermost track of the optical disc 102, whereas the limit of rotation of the optical disc 102 exceeds the limit speed of the signal processing for recording/reproduction of information in the vicinity of the outermost track of the optical disc 102.

A quotient obtained by dividing the revolution number information by the linear velocity information is multiplied by the maximum value of the linear velocity information (this maximum value is set in the multiplication circuit 112 and is hereinafter referred to as “reference value”), whereby the number of revolutions which corresponds to the limit of a signal processing at a certain information recording/reproduction position (hereinafter, referred to as “allowable revolution number A”) is obtained. However, in the present embodiment, the limit number of revolutions of a rotation mechanism does not reach allowable revolution number A in the vicinity of the innermost track of the optical disc 102. The quotient which is obtained by dividing the revolution number information by the linear velocity information decreases as the information recording/reproduction position moves from the innermost track to the outermost track. Specifically, assuming that an arithmetic operation result obtained by dividing the maximum value of the revolution number information by the maximum value of the linear velocity information is quotient B, quotient B is a quotient obtained when the information recording/reproduction position is at a position where the limit of rotation of the optical disc 102 and the limit of the velocity of the signal processing switch with each other. An arithmetic operation result value obtained by multiplying a value equal to or greater than quotient B by the reference value represents the number of revolutions which exceeds the limit of the rotation mechanism. Thus, the quotient must be equal to or smaller than quotient B such that the disc rotation mechanism maintains the limit number of revolutions with which disc rotation is actually enabled. To this end, the limit circuit (numerical range limiting means and upper limit means) 111 is provided at a subsequent stage of the division circuit 110 to impose a limitation such that a value equal to or greater than quotient B is replaced with quotient B. Herein, even if the revolution number information and the linear velocity information include an error in the number of revolutions (revolution number error), “revolution number information not including a revolution number error” is obtained by a series of above-described arithmetic operations performed by the division circuit 110, the limit circuit 111 and the multiplication circuit 112 because the revolution error component is canceled by the above division operation. Subtraction of the obtained revolution number information and “revolution number information including the revolution number error” which is an output of the FG cycle counter 109 is performed, whereby only the revolution number error is obtained. This revolution number error is supplied to the motor driving circuit 103 as the rotation control information, based on which the rotational velocity of the spindle motor 101 is controlled.

Reference numeral 114 denotes a variation detecting circuit (abnormality detecting means) which monitors the output value of the division circuit 110. When an abnormality occurs in the linear velocity information, the variation detecting circuit 114 detects the abnormality by detecting an abrupt change in the division result value to output a linear velocity abnormality signal. This signal is input to a switch 115 as a signal for opening the switch 115, whereby the output of the motor driving circuit 103 is prevented from being applied to the spindle motor 101.

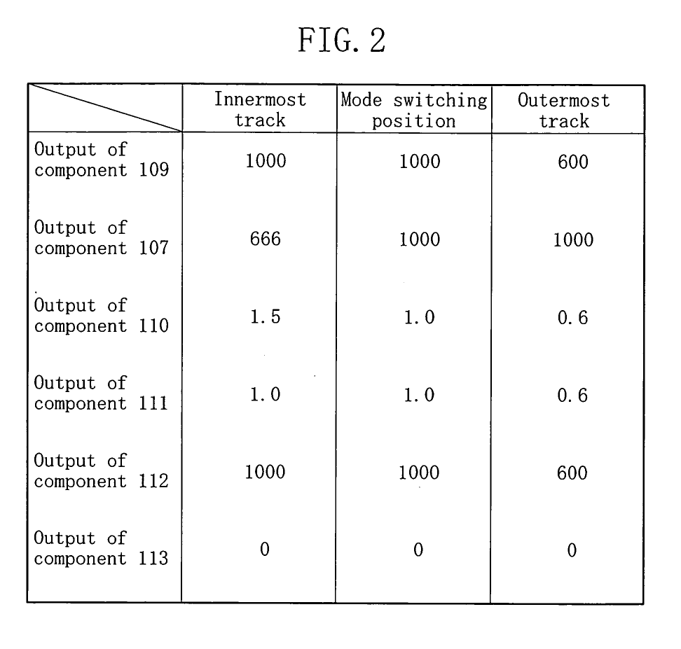

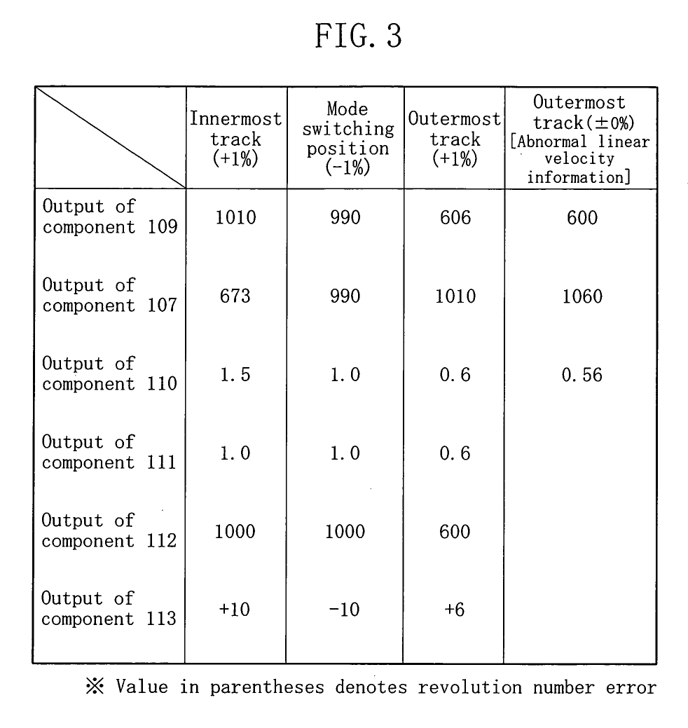

Next, the operation of the rotational velocity controlling system for an information recording medium according to the present embodiment in the case of CD-R/RW is described with reference to FIGS. 2 and 3. Herein, it is assumed that the operation limit speed of the signal processing system (hereinafter, referred to as “signal processing limit”) is 30×-speed, and the mechanical revolution number limit (hereinafter, referred to as “limit of the rotation mechanism”) is 10000 rpm. Furthermore, for convenience of description, the output value of the synchronous signal cycle counter 107 at the signal processing limit (precisely, immediately before the limit) is 1000, and the output value of the FG cycle counter 109 at the limit of the rotation mechanism is 1000. Accordingly, the number of revolutions for the signal processing limit speed of 30× is 15000 rpm at the innermost track and 6000 rpm at the outermost track. Herein, it is assumed in the present embodiment, the limit value of the limit circuit 111 is 1.0, and the reference value held by the multiplication circuit 112 is 1000.

FIG. 2 shows the output values from respective component blocks for the innermost track, a position where the control mode is switched between CLV control mode and CAV control mode, and the outermost track, which are obtained in the case where rotation is desirably control.

At the innermost track, the limit of the number of revolutions of the recording/reproducing apparatus is defined by the limit value of the rotation mechanism. Herein, the revolution number information is the limit value of the rotation mechanism, i.e., 1000. On the other hand, the linear velocity information is 666, which is obtained by dividing the value of the limit revolution number of the rotation mechanism, 10000, by the number of revolutions at the innermost track for the signal processing limit speed, 15000, and multiplying a resultant quotient by the maximum value of the linear velocity information, 1000. Accordingly, the output value of the division circuit 110 is 1.5, which is obtained by dividing the value of the revolution number information, 1000, by the value of the linear velocity information, 666. This quotient is limited by the limit circuit 111 to 1.0. Due to this limited value (1.0), the output of the multiplication circuit 112 results in 1000. In the subtraction circuit 113 at the subsequent stage, the resultant value 1000 is subjected to subtraction with the value of the revolution number information output by the FG cycle counter 109, 1000, whereby a resultant value 0 is output from the subtraction circuit 113. That is, ideal rotation is achieved so that, in this case, no revolution number error occurs.

On the other band, at the outermost track, the limit of the recording/reproducing apparatus is defined by the signal processing limit. In the present embodiment, the number of revolutions for the signal processing limit is 6000 rpm, and accordingly, the value of the revolution number information is 600. Further, the linear velocity information is 1000 at maximum. In this case, the quotient obtained by the division circuit 110 is 0.6, and the value of 0.6 is output from the limit circuit 111 with no value limitation. As a result, the multiplication circuit 112 outputs the value of 600, and accordingly, the subtraction circuit 113, which receives the value of 600, outputs the value of 0. The physical radial position of the optical head 104 at which recording/reproduction is performed is moved toward an outer track, the number of revolutions of the optical disc 102 is reduced such that an increase in the output value of 1000 of the synchronous signal cycle counter 107 is suppressed. Thus, the number of revolutions of the optical disc 102 is automatically controlled to be small as compared with a case where the optical head 104 is at an inner track.

At the mode switching position, i.e., at a position where both the signal processing speed and the capacity of the rotation mechanism are at their limits, both the revolution number information and the linear velocity information are 1000. Then, the above-described arithmetic operations are performed with this value of 1000, and the output value of the subtraction circuit 113 results in 0. That is, ideal rotation is achieved so that no revolution number error occurs.

FIG. 3 is a table showing output values from respective components for the innermost track, the mode switching position and the outermost track, with an error occurring in the rotation control. In an example described herein, the revolution number error is +1% at the innermost track, −1% at the mode switching position, and +1% at the outermost track.

At the innermost track, the value of the linear velocity information is 673 when the value of the revolution number information is 1010. These values are applied to the arithmetic operations as described above with reference to FIG. 2, whereby the output value of the multiplication circuit 112 results in 1000. With the same operations, the output values of the multiplication circuit 112 for the mode switching position and the outermost track result in 1000 and 600, respectively. These results indicate that the error has been canceled by division so that the same values as the output values of the multiplication circuit 112 shown in FIG. 2 are achieved. As a result, the revolution number error for each position is obtained by the subtraction circuit 113.

FIG. 3 also shows a case where the linear velocity information is in an abnormal state due to a flaw on the information recording medium, or the like, at the outermost track. Herein, the output value of the FG cycle counter 109 is 600, which indicates that no error occurs in the number of revolutions. However, the output value of the synchronous signal cycle counter 107 is 1060, which indicates that the error of 6% occurs in the number of revolutions. That is, this means that an abnormality occurs in the linear velocity information. Thus, the output of the division circuit 110 results in 0.56.

In this embodiment, an abnormality in the linear velocity information is detected by detecting a variation in the output of the division circuit 110. In a normal state, the output of the division circuit 110 continuously changes within a range of 1.5 to 0.6 depending only on the physical radial position on the recording medium where recording/reproduction is performed. In this embodiment, recording/reproduction from the innermost track to the outermost track requires about 2 minutes, during which the quotient continuously changes within the above range. Thus, an irregular change in the quotient, for example, from 0.6 to 0.56 as shown in FIG. 3, never happens, and therefore, an abnormality is determined based on occurrence of such an irregular change. In this embodiment, when such an abnormality is detected, the switch circuit 115 is opened so that an abnormal spindle control signal is prevented from being applied to the spindle motor 101.

It should be noted that, although in this embodiment the division operation at the division circuit 110 is achieved by dividing the revolution number information by the linear velocity information, the division operation may be achieved by dividing the linear velocity information by the revolution number information, conversely.

What is claimed is:

1. A rotational velocity controlling system in an information recording/reproducing apparatus which records and reproduces information on/from an information recording medium, the system comprising:
revolution number detecting means for detecting the number of revolutions of the information recording medium;
linear velocity detecting means for detecting the linear velocity at an information recording/reproduction position on the information recording medium;
control information generating means for generating rotation control information used for controlling the rotational velocity of the information recording medium based on the revolution number information obtained by the revolution number detecting means and the linear velocity information obtained by the linear velocity detecting means; and
driving means for rotating the information recording medium based on the rotation control information generated by the control information generating means.

2. The rotational velocity controlling system of claim 1, wherein:
the control information generating means uses the revolution number information obtained by the revolution number detecting means and the linear velocity information obtained by the linear velocity detecting means to divide one of these information by the other;
the control information generating means generates a revolution number error from the revolution number information based on an operation result value obtained by the division; and
the control information generating means outputs the revolution number error as the rotation control information to the driving means.

3. The rotational velocity controlling system of claim 2, wherein the control information generating means includes numerical range limiting means for limiting the numerical range of the operation result value.

4. The rotational velocity controlling system of claim 3, wherein the numerical range limiting means is upper limit means for limiting an operation result value which exceeds a predetermined value to the predetermined value.

5. The rotational velocity controlling system of claim 1, further comprising abnormality detecting means for detecting occurrence of an abnormality in the output of the linear velocity detecting means according to the relationship between the revolution number information and the linear velocity information.
